(19) United States
(12) Patent Application Publication
(10) Pub. No.: US 2004/0109933 A1
(43) Pub. Date: Jun. 10, 2004

(54) Aerated confection containing high levels of fruit solids and method of making same

(76) Inventors: Pradip Roy, Grand Rapids, MI (US); Emery Okos, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/698,799

(22) Filed: Oct. 31, 2003

Related U.S. Application Data
(60) Provisional application No. 60/422,812, filed on Oct. 31, 2002.

(51) Int. Cl. A23G 3/00

(52) U.S. Cl. 426/660

(57) ABSTRACT

An aerated confection containing high levels of fruit solids and method for making the same is disclosed. The method allows the incorporation of fruit solids at a level of from 0.5 to 20.0% by weight on a dry weight basis making the aerated confection similar to that of most real fruits. The aerated confection preferably includes hexametaphosphate as a gel-stiffening agent.

### RELATED APPLICATIONS

This application claims the benefit of U.S. Provisional application No. 60/422,812 filed on Oct. 31, 2002.

### STATEMENT REGARDING FEDERALLY SPONSORED RESEARCH

None

### BACKGROUND OF THE INVENTION

This invention relates generally to aerated confections such as marbits and marshmallows and, more particularly, to including high levels of fruit solids in such aerated confections.

Aerated confections such as marbits and marshmallows have been known for many years. A marbit is basically a marshmallow formulation that has been dried to a moisture level of generally less than 5%. Marshmallows typically have moisture contents of from 10 to 30%. Past formulations for marbits and marshmallows have included different colors, flavors, or both. Generally, the color has been added by utilizing dyes and the flavor has been added by utilizing flavor extracts or additives. One thing that has been lacking from past marbits and marshmallows has been the incorporation of real fruit solids into the formulation to produce a marbit or marshmallow containing real fruit solids. Prior reports had suggested the use of fruit juices, however, it was found by the present inventors that the acidity of these juices hydrolyzes sugars in the formulation leading to an unworkable formulation. It would be advantageous to develop a method enabling the incorporation of high levels of fruit solids into marbits and marshmallows to produce additional textures, tastes, flavors, and to enhance the nutritional composition of the same.

### SUMMARY OF THE INVENTION

In one embodiment the present invention is an aerated confection comprising from 0.5 to 20% by weight on a dry weight basis of fruit solids based on the total weight of the aerated confection and from 0.01 to 0.2% by weight of a hexametaphosphate based on the total weight, the aerated confection having a moisture content of from 1 to 5% by weight.

In another embodiment the present invention is an aerated confection comprising from 0.5 to 20% by weight on a dry weight basis of fruit solids based on the total weight of the aerated confection and from 0.01 to 0.2% by weight of a hexametaphosphate based on the total weight, the aerated confection having a moisture content of from 10 to 30% by weight.

In another embodiment the present invention is a method of forming an aerated confection comprising the steps of providing a sucrose solution comprising sucrose and water at a temperature above the crystallization temperature of the sucrose solution; cooling the sucrose solution to a temperature at or below its crystallization temperature; adding to the cooled sucrose solution of step b) an amount of from 0.5 to 20% by weight of fruit solids based on the final weight of the mallow mixture; further cooling the solution from step c) and adding to the solution from 0.5 to 15% by weight of a film forming agent and from 0.01 to 0.2% by weight of a hexametaphosphate, both based on the final weight of the mallow mixture; and aerating the mallow mixture to a density of from 1.5 to 4 pounds per gallon to form the aerated mallow mixture.

These and other features and advantages of this invention will become more apparent to those skilled in the art from the detailed description of a preferred embodiment. The drawings that accompany the detailed description are described below.

### BRIEF DESCRIPTION OF THE DRAWINGS

FIG. 1 is a schematic diagram of the process according to the present invention.

### DETAILED DESCRIPTION OF A PREFERRED EMBODIMENT

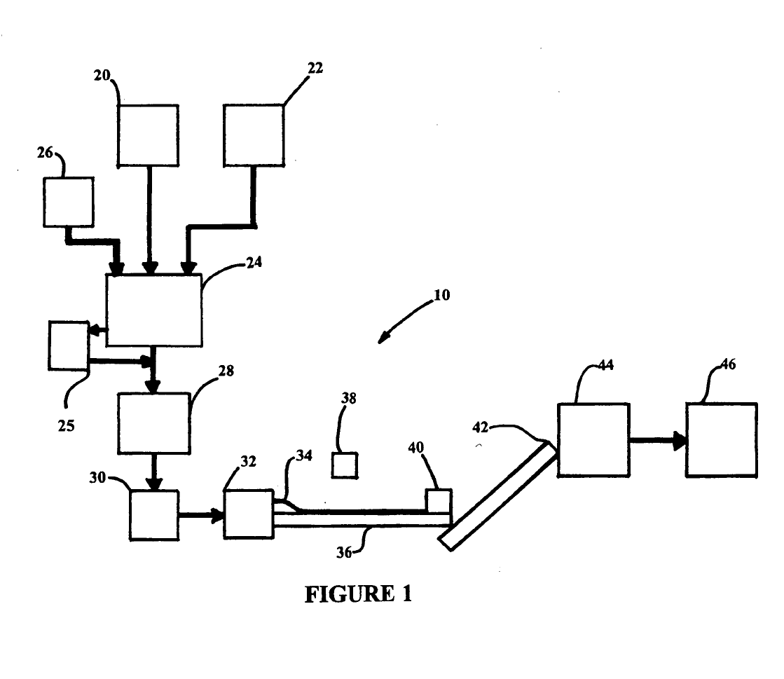

In FIG. 1, a schematic diagram of the present process is shown generally at 10. In an initial step, a sucrose solution is prepared in a first tank 20. Tank 20 is thermally controlled and includes a mixer. The sucrose solution is prepared with water to have a solids level of from 82 to 89% and more preferably from 84 to 87%. In addition to sucrose the solution typically includes corn syrup, dextrose, or a mixture of corn syrup and dextrose. The sucrose solution can also be made without corn syrup, dextrose, or both, using instead maltose, lactose, glycerin, maltodextrin, a glucose syrup, or mixtures thereof. The components other than the sucrose are utilized to reduce the tendency for crystallization of the sucrose. In a preferred embodiment, the sucrose solution comprises sucrose, corn syrup, dextrose, and water. In such a sucrose solution there is preferably from 5.0% to 50.0% by weight of corn syrup, dextrose, substitutes for these noted above, or a combination thereof with the remainder comprising water and sucrose. In a typical preparation, the water, sucrose and corn syrup are initially mixed together and heated in first tank 20 to approximately 200° F. Once the sucrose has been hydrated the dextrose is added and the mixture is elevated to a temperature of from 243 to 246° F. with mixing to form the sucrose solution.

A second component is the formation of a film-forming solution in a second tank 22. Second tank 22 is thermally controlled and includes a mixer. A preferred film-forming agent is gelatin; however, other film-forming agents that could be utilized include proteins such as albumin, pectin, carboxymethyl cellulose, alginate, a gum, or mixtures of these film forming agents. Gums that are typically utilized include guar gum, carrageenan, arabic gum, and xanthan gum. The preferred film-forming agent in the present invention is a gelatin, either type A or type B. Two especially preferred gelatins are 225B and 225A. When gelatin is the selected film-forming agent it is heated in water in the second tank 22 at approximately 170° F. to hydrate the film-forming agent and form the film-forming solution. When gelatin is utilized it is generally hydrated with water in a weight to weight ratio of 1:2; thus the solution is 33.33% gelatin and 66.67% water. The other film forming agents are also hydrated as known in the art. Typically at least 30 minutes are required for full hydration of the film-forming agent. Once hydrated, the film-forming solution is maintained at a temperature of from 150 to 165° F. in second tank 22.

The sucrose solution is then pumped into a third tank 24, which is also thermally controlled and includes mixing. The third tank 24 is initially set at a temperature of from 165 to 180° F. Preferably, the third tank 24 is initially set at a temperature of from 175 to 180° F. Once the sucrose solution is completely pumped into the third tank 24 it begins to cool to the initially set temperature. When the sucrose solution reaches a temperature of approximately 180° F. or below crystallization of the sucrose solution begins to occur at this its crystallization temperature. Once the sucrose solution has cooled to 180° F. additional components are added to the sucrose solution from a source tank 26 to form a mallow mix. For simplicity, only a single source tank 26 is shown, however, as would be understood by one of ordinary skill in the art numerous source tanks may be utilized, all feeding into third tank 24.

Once the sucrose solution reaches a temperature of 180° F., the fruit solids are added from a source tank 26 into the mallow mix in third tank 24. Preferably, the fruit solids are added in the form of a dry fruit powder, but wet fruit solids can also be added provided they have a very high solids content of at least 80%. Preferably, the amount of fruit solids on a dry weight basis based on the final weight of the mallow mix comprises from 0.5 to 20.0%, more preferably from 0.5 to 10.0%, and most preferably from 2.0 to 5.0% by weight. The fruit solids can be prepared by a number of known techniques including: drum dried fruit, spray dried fruit, freeze dried fruit, or evaporated fruit puree at a high solids of over 80%. The fruit solids added to third tank 24 can comprise a mixture of any combination of fruit solids that is desired. It is important to add the fruit solids at this point in the procedure. To maintain the nutritional content of the fruit solids it is important that they not be exposed to high temperatures of generally greater than 180° F. Because, unlike the prior art the present invention uses fruit solids as either dry powders or very high solids wet solids it is not necessary to drive off excess water that is present in the prior art. The prior art has suggested fruit juices or purees, both of which have very high water levels, thus they must be added to the sucrose solution at high temperatures during hydration of the sucrose solution so the excess water can be driven off.

At the same time the fruit solids are added to third tank 24, a seed sugar in an amount of from 1.0 to 20.0% on a dry weight basis based on the total mallow mix weight is added to the mallow mix. Seed sugars ranked in increasing grain size that are useful in the present invention include: 10× powdered sugar; 6× powdered sugar; Bakers Special sugar; fruit sugar; extra fine granulated sugar; fine granulated sugar; and mixtures thereof. Any of these seed sugars alone or in combination is suitable. Especially preferred is a powdered sugar sized to 5% on a 100 USS mesh screen and 80% thru a 200 USS mesh screen. Also especially preferred is a Bakers Special Sugar sized to 2% on a 50 USS mesh screen and 5% thru a 200 USS mesh screen. The mallow mix with the added seed sugar and fruit solids continues to be cooled and mixed until the temperature reaches approximately 165° F. Once the mallow mix reaches a temperature of 160° F., the film-forming solution from the second tank 22 is added to third tank 24. The film-forming solution is added in sufficient amount to provide an amount of preferably from 0.5 to 15.0% by weight on a dry weight basis of the film forming agent or agents based on the total weight of the mallow mix. More preferably the film forming agent or agents are present in an amount of from 1.0 to 7.0% by weight on a dry weight basis based on the total weight of the mallow mix. Also flavors, colors, and a colloidal solution of hexametaphosphate are added from a source tank 26 to the mallow mix. Flavor and colors are added in amounts of from 0.1 to 3.0% by weight. The preferred hexametaphosphate is the sodium salt, although the potassium salt can also be utilized. The hexametaphosphate is preferably added in an amount of from 0.01 to 0.2% and more preferably from 0.02 to 0.05% by weight. The hexametaphosphate is necessary to allow the film-forming solution to firmly gel the final mallow mix to enable formation of an extrudable mass that can be cut into discrete pieces, as described below.

The mallow mix is mixed and cooled until it reaches a temperature of approximately 145° F. The preferred density of the mallow mix is from 11.0 to 12.0 pounds per gallon with a moisture level of from 10 to 30% at this point in the procedure. If the fruit solids are added as a wet solids solution the contents of third tank 24 can be passed through an evaporator 25 such as a rotary evaporator, or microfilm cooker or other rapid evaporator to bring the final solids back to a range of from 82 to 86%.

In a next step the mallow mix formed in third tank 24 is pumped into an aerator 28. The aerator 28 is any of a commonly known variety such as Mondo Mixer™ or an Oakes™-type aerator. The aerator 28 is thermally controlled to a temperature range of from 125 to 165° F. The mallow mix is aerated to a density of from 1.5 to 4.0 pounds per gallon and more preferably from 2.0 to 3.0 pounds per gallon. The aerated mallow mix is then pumped from aerator 28 through a thermally controlled tube 30. The aerated mallow mix is preferably cooled to a temperature range of from 90 to 170° F., more preferably to a temperature of from 115 to 145° F., and most preferably to a temperature of from 125 to 135° F. The chilled, aerated mallow mix is then pumped to an extruder 32 and extruded into a rope 34 having any of a plurality of desired shapes. The extruded rope 34 exits the extruder 32 onto a moving bed conveyor 36 coated with a non-stick coating such as dextrose, glucose, dusting starch, or wax. These non-stick coatings prevent the rope 34 from sticking to the conveyor 36. Additional non-stick coating is deposited onto the top of the rope 34 by a duster 38. The extruded rope 34 is preferably conveyed from the extruder 32 to a cutter 40 over a time period of from 2 to 6 minutes. When the rope 34 reaches the cutter 40 it is cut into appropriate sized pieces, which drop onto a second moving bed conveyor 42 where the cut ends are coated with the non-stick coating from adjacent cut pieces. The cut pieces are then conveyed via conveyor 42 to either a combination dusting and de-dusting drum 44 or through two separate drums comprising a first one for dusting and a second one for de-dusting to remove excess non-stick coating. The two drum embodiment is not shown. Once the cut pieces are de-dusted, if marbits are being made, they are conveyed to a combination dryer and cooler unit 46 and dried at a temperature of from 110 to 250° F., and more preferably from 110 to 160° F., to a final moisture of from 1 to 5%, and more preferably from 2 to 3%. To form marshmallows utilizing the present process the final drying step in the dryer and cooler unit 46 is eliminated and the cut, de-dusted pieces having a moisture of from 10 to 30% are the finished product. Preferably the moisture is from 10 to 25% and more preferably from 10 to 20%.

The hexametaphosphate colloidal solution has been found to be very advantageous in permitting the film-forming solution to sufficiently gel the mallow mix and rope 34 such that it can be cut by cutter 40 in a reasonable time frame. In the absence of hexametaphosphate the rope 34 takes a much longer time to firm and can not be cut uniformly by cutter 40 unless the moving bed conveyor 36 is made very long.

### EXAMPLE 1

Utilizing the general procedure described above marbits were prepared using the solutions described below following the procedure as above. The sucrose solution was prepared per Table 1 below by combining the water, sucrose, and corn syrup in first tank 20 at a temperature of 200° F. The dextrose was then added and the mixture was heated to a temperature of from 243 to 246° F.

TABLE 1

| Component | Kilograms | Percent by Weight |
|---|---|---|
| Sucrose | 81.72 | 65.72 |
| 42 DE Corn Syrup | 15.39 | 12.38 |
| Water | 14.44 | 11.61 |
| Dextrose | 12.8 | 10.29 |
| Total | 124.35 | 100.00 |

The film-forming solution was prepared in second tank 22 utilizing the components described in Table 2 below. The gelatin was heated to 170° F. for at least 30 minutes prior to use and maintained at a temperature of from 150 to 165° F.

TABLE 2

| Component | Kilograms | Percent by Weight |
|---|---|---|
| Gelatin | 2.59 | 33.33 |
| Water | 5.18 | 66.67 |
| Total | 7.77 | 100.00 |

To form the mallow mix the sucrose solution from first tank 20 was pumped into third tank 24 and cooled to 180° F. Then the fruit solids and seed sugar, powdered sugar, were added to third tank 24. The mallow mixture was then cooled to 165° F. at which point the gelatin solution, flavor, color, and colloidal suspension of hexametaphosphate was added. The hexametaphosphate was made up in the water noted in Table 3 below. The components added to third tank 24 are as noted below in Table 3.

TABLE 3

| Component | Kilograms | Percent by Weight |
|---|---|---|
| Sucrose Solution | 121.5 | 89.22 |
| Gelatin Solution | 7.77 | 5.7 |
| Powdered Sugar (seed sugar) | 2.32 | 1.7 |
| Fruit Solids | 3.27 | 2.4 |
| Flavor | 0.572 | 0.42 |
| Liquid Color | 0.594 | 0.44 |
| Sodium Hexametaphosphate | 0.027 | 0.02 |
| Water | 0.136 | 0.10 |
| Total | 136.23 | 100.00 |

The formed mallow mix is then pumped through aerator 28 to produce a density of 2.2 pounds per gallon. The aerated solution was pumped through a thermally controlled tube 30 and chilled to 125° F. The chilled solution was then extruded through extruder 32 with final treatment being as described above under the general procedure.

### EXAMPLE 2

Utilizing the general procedure described above Kosher marbits were prepared using the solutions described below following the procedure as above. The sucrose solution was prepared per Table 4 below by combining the water, sucrose, and corn syrup in first tank 20 at a temperature of 200° F. The dextrose was then added and the mixture was heated to a temperature of from 243 to 246° F.

TABLE 4

| Component | Kilograms | Percent by Weight |
|---|---|---|
| Sucrose | 81.72 | 65.69 |
| 64 DE Corn Syrup | 15.44 | 12.41 |
| Water | 14.53 | 11.68 |
| Dextrose | 12.71 | 10.22 |
| Total | 124.40 | 100.00 |

The film-forming solution used was egg albumen hydrated in cold water, strained, and added to tank 22 utilizing the components described in Table 5 below.

TABLE 5

| Component | Kilograms | Percent by Weight |
|---|---|---|
| Egg Albumen | 5.45 | 33.33 |
| Water | 10.90 | 66.67 |
| Total | 16.34 | 100.00 |

To form the mallow mix the sucrose solution from first tank 20 was pumped into third tank 24 and cooled to 180° F. Then the fruit solids and seed sugar, powdered sugar, were added to third tank 24. The mallow mixture was then cooled to 140° F. at which point the albumen solution, flavor, and solution of hexametaphosphate was added. The hexametaphosphate was made up in the water noted in Table 6 below. The components added to third tank 24 are as noted below in Table 6

TABLE 6

| Component | Kilograms | Percent by Weight |
|---|---|---|
| Sucrose Solution | 122.2 | 84.53 |
| Albumen Solution | 16.34 | 11.31 |
| Powdered Sugar (seed sugar) | 2.32 | 1.60 |
| Fruit Solids | 3.27 | 2.26 |
| Flavor | 0.272 | .19 |
| Sodium Hexametaphosphate | 0.027 | .019 |
| Water | 0.136 | 0.09 |
| Total | 136.23 | 100.00 |

The formed mallow mix is then pumped through aerator 28 to produce a density of 2.2 pounds per gallon. The aerated solution was pumped through a thermally controlled tube 30 and chilled to 125° F. The chilled solution was then extruded through extruder 32 with final treatment being as described above under the general procedure.

The present invention discloses a method for incorporating very high levels of fruit solids into either marbits or marshmallows, unlike previously disclosed formulations. The marbits and marshmallows according to the present invention have nearly identical fruit solids contents to those of real fruit. For example, most fruits range from 85 to 92% water with the rest being solids. Even high solids content fruits such as bananas contain only 25% solids by weight. The foregoing invention has been described in accordance with the relevant legal standards; thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1.) An aerated confection comprising from 0.5 to 20% by weight on a dry weight basis of fruit solids based on the total weight of said aerated confection and from 0.01 to 0.2% by weight of a hexametaphosphate based on the total weight, said aerated confection having a moisture content of from 1 to 5% by weight.

2.) The aerated confection of claim 1, wherein said fruit solids are present in an amount of from 0.5 to 10% by weight.

3.) The aerated confection of claim 1, wherein said fruit solids are present in an amount of from 2 to 5% by weight.

4). The aerated confection of claim 1 wherein said fruit solids comprise a dried fruit powder, a drum dried fruit solid, a freeze dried fruit solid, an evaporated fruit puree having a solids level of greater than 80% by weight, or a mixture thereof.

5.) The aerated confection of claim 1 comprising from 0.02 to 0.05% by weight of a hexaametaphosphate.

6.) The aerated confection of claim 1 having a moisture content of from 2 to 3% by weight.

7.) The aerated confection of claim 1 further comprising from 0.1 to 3% by weigh of at least one flavor or color.

8.) The aerated confection of claim 1 further comprising from 1 to 20% by weight on a dry weight basis of seed sugar.

9.) The aerated confection of claim 1 further comprising from 0.5 to 15% by weight of a film forming agent.

10.) The aerated confection of claim 9 wherein said film forming agent comprises a gelatin, an albumin, a pectin, a carboxymethyl cellulose, an alginate, a gum, or mixtures thereof.

11.) The aerated confection of claim 10 wherein said gum comprises a guar gum, a carrageenan, an arabic gum, a xanthan gum, or mixtures thereof.

12.) The aerated confection of claim 9 wherein said film forming agent is present in an amount of from about 1 to 7% by weight.

13.) The aerated confection of claim 1 further comprising sucrose, corn syrup, dextrose, maltose, lactose, glycerin, maltodextrin, a glucose syrup, or mixtures thereof.

14.) An aerated confection comprising from 0.5 to 20% by weight on a dry weight basis of fruit solids based on the total weight of said aerated confection and from 0.01 to 0.2% by weight of a hexametaphosphate based on the total weight, said aerated confection having a moisture content of from 10 to 30% by weight.

15.) The aerated confection of claim 14, wherein said fruit solids are present in an amount of from 0.5 to 10% by weight.

16.) The aerated confection of claim 14, wherein said fruit solids are present in an amount of from 2 to 5% by weight.

17.) The aerated confection of claim 14 wherein said fruit solids comprise a dried fruit powder, a drum dried fruit solid, a freeze dried fruit solid, an evaporated fruit puree having a solids level of greater than 80% by weight, or a mixture thereof.

18.) The aerated confection of claim 14 comprising from 0.02 to 0.05% by weight of a hexametaphosphate.

19.) The aerated confection of claim 14 having a moisture content of from 10 to 25% by weight.

20.) The aerated confection of claim 14 having a moisture content of from 10 to 20% by weight.

21.) The aerated confection of claim 14 further comprising from 1 to 20% by weight on a dry weight basis of seed sugar.

22.) The aerated confection of claim 14 further comprising from 0.5 to 15% by weight of a film forming agent.

23.) The aerated confection of claim 22 wherein said film forming agent comprises a gelatin, an albumin, a pectin, a carboxymethyl cellulose, an alginate, a gum, or mixtures thereof.

24.) The aerated confection of claim 23 wherein said gum comprises a guar gum, a carrageenan, an arabic gum, a xanthan gum, or mixtures thereof.

25.) The aerated confection of claim 22 wherein said film forming agent is present in an amount of from about 1 to 7% by weight.

26.) The aerated confection of claim 14 further comprising sucrose, corn syrup, dextrose, maltose, lactose, glycerin, maltodextrin, a glucose syrup, or mixtures thereof.

27.) The aerated confection of claim 14 further comprising from 0.1 to 3% by weight of at least one flavor or color.

28.) A method for preparing an aerated mallow mixture comprising the steps of:
a) providing a sucrose solution comprising sucrose and water at a temperature above the crystallization temperature of the sucrose solution;
b) cooling the sucrose solution to a temperature at or below its crystallization temperature;
c) adding to the cooled sucrose solution of step b) an amount of from 0.5 to 20% by weight of fruit solids based on the final weight of the mallow mixture;
d) further cooling the solution from step c) and adding to the solution from 0.5 to 15% by weight of a film forming agent and from 0.01 to 0.2% by weight of a hexametaphosphate, both based on the final weight of the mallow mixture; and
e) aerating the mallow mixture to a density of from 1.5 to 4 pounds per gallon to form the aerated mallow mixture.

29.) The method of claim 28 wherein step a) comprises providing a sucrose solution having a solids level of from about 82 to 89%.

30.) The method of claim 28 wherein step a) comprises providing a sucrose solution comprising sucrose, water and at least one of a corn syrup, a dextrose, a maltose, a lactose, a glycerin, a maltodextrin, a glucose syrup, or mixtures thereof.

31.) The method of claim 28 wherein step a) comprises providing the sucrose solution at a temperature of from 200 to 250 degrees Fahrenheit.

32.) The method of claim 28 wherein step b) comprises cooling the sucrose solution to a temperature of from 165 to 180 degrees Fahrenheit.

33.) The method of claim 28 wherein step c) comprises adding a dried fruit powder, a drum dried fruit solid, a freeze dried fruit solid, an evaporated fruit puree having a solids level of greater than 80% by weight, or a mixture thereof.

34.) The method of claim 28 wherein step c) comprises adding an amount of from 0.5 to 10% by weight of fruit solids based on the final weight of the mallow mixture.

35.) The method of claim 28 wherein step c) comprises adding an amount of from 2 to 5% by weight of fruit solids based on the final weight of the mallow mixture.

36.) The method of claim 28 wherein step c) further comprises adding from 1 to 20% by weight of a seed sugar on a dry weight basis based on the final weight of the mallow mixture to the cooled sucrose solution.

37.) The method of claim 28 wherein step d) further comprises providing a film forming agent comprising at least one of a gelatin, an albumin, a pectin, a carboxymethyl cellulose, an alginate, a gum, or mixtures thereof.

38.) The method of claim 37 wherein step d) further comprises selecting a the gum at least one of a guar gum, a carrageenan, an arabic gum, a xanthan gum, or mixtures thereof.

39.) The method of claim 28 wherein step d) comprises providing the film forming agent in an amount of from 1 to 7% by weight.

40.) The method of claim 28 wherein step d) comprises providing the hexametaphosphate in an amount of from 0.02 to 0.05% by weight.

41.) The method of claim 28 wherein step d) further comprises adding at least one flavor or color in an amount of from 0.1 to 3% by weight based on the final weight of the mallow mixture.

42.) The method of claim 28 wherein step e) comprises aerating the mallow mixture to a density of from 2 to 3 pounds per gallon.

43.) The method of claim 28 further comprising extruding the aerated mallow mixture, cutting the extruded mallow mixture into pieces to form aerated confection pieces having a moisture content of from 10 to 30%.

44.) The method of claim 28 further comprising extruding the aerated mallow mixture, cutting the extruded mallow mixture into pieces, and drying the pieces to a moisture content of from 1 to 5% to form an aerated confection having a moisture content of from 1 to 5%.

45.) The method of claim 44 comprising drying the pieces to a moisture content of from 2 to 3%.
